(19) United States
(12) Patent Application Publication
(10) Pub. No.: US 2008/0221984 A1
(43) Pub. Date: Sep. 11, 2008

(54) User-managed coupons in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/716,198

(22) Filed: Mar. 8, 2007

(51) Int. Cl. G06Q 30/00

(52) U.S. Cl. 705/14

(57) ABSTRACT

A method, apparatus, and system of user-managed coupons in a geo-spatial environment are disclosed. In one embodiment, a method includes automatically applying a location meta-data to a coupon when a user provides the coupon to a geo-spatial environment based on a geographic marker of the user, storing the coupon in a library of coupons, searching the library of coupons based on the location meta-data based on a user request and flagging certain coupons in the library of coupons as being expired based on a user response. The method may further include providing an incentive to the user who provides the coupon to the geo-spatial environment in exchange of providing the coupon and/or in exchange of sharing a content meta-data that tags and identifies a source, duration, a value, and/or a description of the coupon.

This patent application is being filed simultaneously with an international PCT patent application, titled “USER-MANAGED COUPONS IN A GEO-SPATIAL ENVIRONMENT.”

### FIELD OF TECHNOLOGY

This disclosure relates generally to the technical fields of communications and, in one example embodiment, to a method, apparatus, and system of user-managed coupons in a geo-spatial environment.

### BACKGROUND

A coupon (e.g., a discount, a rebate, an incentive, etc.) may increase sales of a particular product and/or service. The coupon may be distributed through postal mail or through the Internet. When the coupon is distributed through postal mail, the coupon may be inserted in a newspaper, a magazine, a pamphlet, and/or a coupon book (e.g., Valpak®). When the coupon is distributed through the Internet, the coupon may be posted on a website or included as part of an electronic communication (e.g., email).

In many neighborhoods, there are individuals (e.g., moms, dads, grandmas, etc.) who love coupons. Such individuals may regularly cut coupons received in postal mail and store them at home (e.g., a drawer in a kitchen). These individuals may share printed coupons with friends and/or family members by searching through their drawer in hope of saving money for their friends and/or family. These individuals may take pride in being recognized for their thriftiness. In addition, such individuals may enjoy helping others save money and find good deals. Sometimes, the coupons in the drawer may be expired and/or unusable. In addition, manually searching for a particular coupon in a drawer can be inefficient and time consuming. As such, the individuals who love coupons may find it difficult to share them with others.

In addition, distribution of the coupons can be very expensive. The coupons may be discarded and/or ignored by recipients (e.g., postal mail recipients and/or electronic communication recipients) who are not interested in the particular product and/or service promoted by the coupons. In addition, mailing costs to distribute the coupons can be enormous (e.g., in aggregate totaling billions of dollars in the United States alone). As such, sharing and/or distribution of coupons is inefficient, expensive, and time consuming.

### SUMMARY

A method, apparatus, and system of user-managed coupons in a geo-spatial environment is disclosed. In one aspect, a method includes automatically applying a location meta-data to a coupon when a user provides the coupon to the geo-spatial environment based on a geographic marker of the user (e.g., the user who provides the coupon may scan in a coupon received by the user through printed mail and may upload the coupon to the geo-spatial environment after registering location information in a geo-spatial environment), storing the coupon in a library of coupons, searching the library of coupons based on the location meta-data based on a user request, and flagging certain coupons in the library of coupons as being expired based on a user response.

The method may further include providing an incentive (e.g., the incentive may be a portion of the value of the coupon applied as a credit) to the user who provides the coupon to the geo-spatial environment in exchange of providing the coupon and/or in exchange of sharing a content meta-data that tags and identifies a source, a duration, a value, and/or a description of the coupon. The coupon may be debited against the user who provides the coupon to the geo-spatial environment when it is flagged as expired prior to being redeemed by another user in the geo-spatial environment.

The method may also include providing an added bonus to the user who provides the coupon when the coupon is redeemed by another user in the geo-spatial environment prior to expiry of the coupon. Moreover, the method may include enabling another user to purchase an offering identified through the coupon in the geo-spatial environment and applying the coupon to the offering when a transaction between another user and a seller is processed.

Furthermore, the method may include generating a premium coupon in the geo-spatial environment which is highlighted in a search result when an advertiser pays the geo-spatial environment to place the premium coupon in the geo-spatial environment (e.g., the advertiser may bid along with other advertisers to place the premium coupon in the search result based on a bidding competition between advertisers tagged to the location meta-data and/or the content meta-data).

In addition, the method may include enabling users to browse the library of coupons in a singular and/or group fashion. The method may further include enabling the users to print out a coupon page and/or a coupon book based on location, topic, description, interest, value, and/or business name. An optical character recognition technology may be applied to the coupon when it is uploaded, to automatically add the location and/or content meta-data in the library of coupons. The method may include performing a modify operation on the coupon to correct and/or improve indexing of the coupon when any user of the geo-spatial network updates, modifies, creates, and/or tags the coupon.

Furthermore, the method may include placing a rating and/or a comments board of uploaded coupons in the geo-spatial environment based on a user feedback provided in the geo-spatial environment and/or enabling the ratings and/or the comments board to recognize prolific and popular ones of the users who provide coupons to be shared in the geo-spatial environment. Moreover, the method may include applying a marker to graphically show the coupon in a geo-spatial wiki based social network along with other markers highlighting profiles of neighbors and/or businesses in a neighborhood.

In another aspect, a system includes a geo-spatial environment having any number of business profiles and/or any number of residential profiles each marked above a three-dimensional view of a neighborhood, a set of markers (e.g., the set of markers may appear only for a determined amount of time based on a meta-data identifying a valid term of the coupons and/or may automatically disappear from the geo-spatial environment when the valid term expires) indicating particular ones of the business profiles which have coupons in the geo-spatial environment as being available for redemption, and a central module to manage the recognition, rewards, and/or promotion of user-generated coupons in the geo-spatial environment between interested ones of users each having residential profiles and/or business profiles and each indicating a physical location of the users. Furthermore, the central module may enable businesses to place premium coupons in the geo-spatial environment which are ordered in search results based on bidding across location-based and/or category-based dimensions.

In yet another aspect, a method includes capturing a location information of each user of a social network through an identification of a location of each user in a map, providing an incentive to the users of the social network to scan and upload coupons to the social network, automatically tagging the uploaded coupons based on the location information of each user and enabling debits and/or credits between users who participate in a user generated coupon exchange between parties in the social network by providing credits and/or debits between business and residential users of the social network based on validity and/or redemption of the coupons in the social network.

In addition, the method may include recognizing popular ones of the users of the social network through ratings and/or popularity score in exchange of sharing coupons with other parties in the social network. Furthermore, the method may include placing a set of premium coupons in the social network that are visually displayed along with other coupons in the map through a set of pushpins that highlight particular locations at which the set of premium coupons and/or the other coupons are redeemable.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows:

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a central module communicating with a geo-spatial environment through a network, according to one embodiment.

FIG. 2 is an exploded view of the coupon module of FIG. 1, according to one embodiment.

FIG. 3 is an exploded view of the exchange module of FIG. 1, according to one embodiment.

FIG. 4 is a user interface view of the coupon module of FIG. 1, according to one embodiment.

FIG. 5 is a user interface view of a coupon zone in a geo-spatial environment, according to one embodiment.

FIG. 6 is a user interface view of a premium coupon module, according to one embodiment.

FIG. 7 is a diagrammatic system view of a data processing system in which any of the embodiments disclosed herein may be performed, according to one embodiment.

FIG. 8 is a table view of data referenced by the central module of FIG. 1, according to one embodiment.

FIG. 9 is a user interface view of mapping of a customizable business profile of the commercial user, according to one embodiment.

FIG. 10 is an exemplary view of a coupon book, according to one embodiment.

FIG. 11A is a process flow of generating coupons in a geo-spatial environment, according to one embodiment.

FIG. 11B is a continuation of the process flow of FIG. 11A showing additional processes, according to one embodiment.

FIG. 11C is a continuation of the process flow of FIG. 11B showing additional processes, according to one embodiment.

FIG. 12 is a process flow of exchanging user generated coupons in the geo-spatial environment, according to one embodiment.

Other features of the present embodiments will be apparent from the accompanying drawings and from the detailed description that follows.

### DETAILED DESCRIPTION

A method, apparatus, and system of user-managed coupons in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

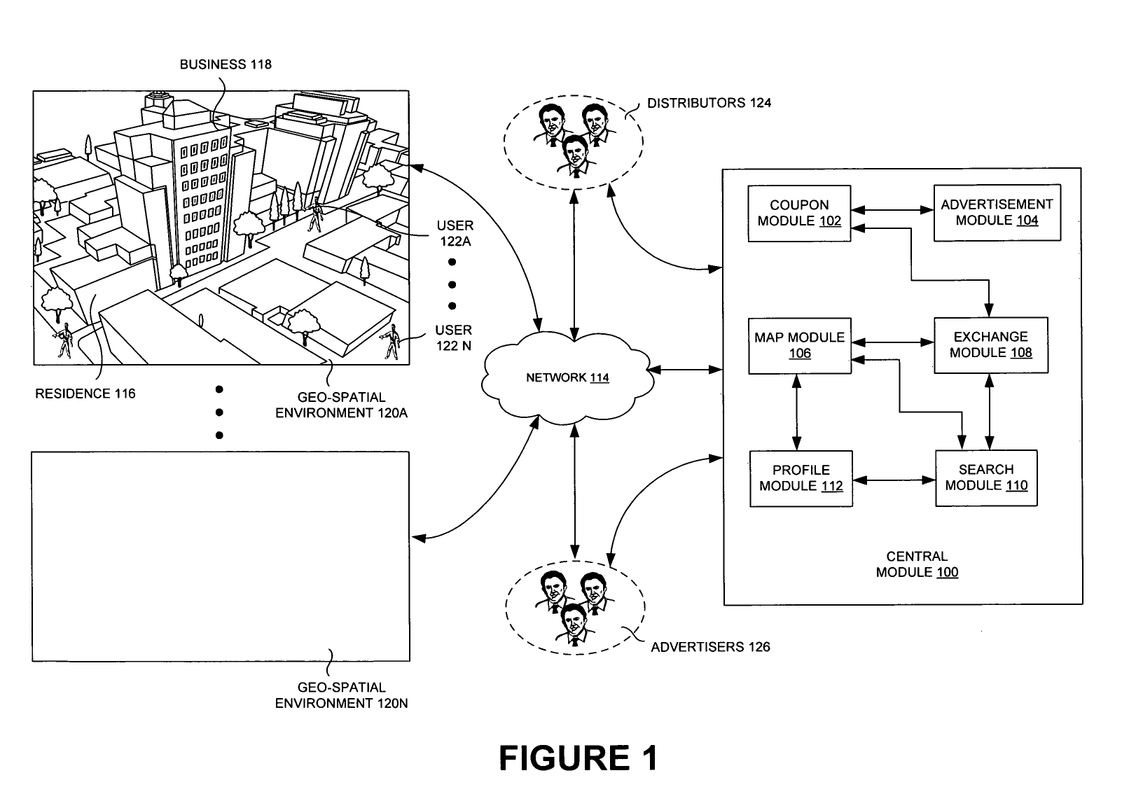

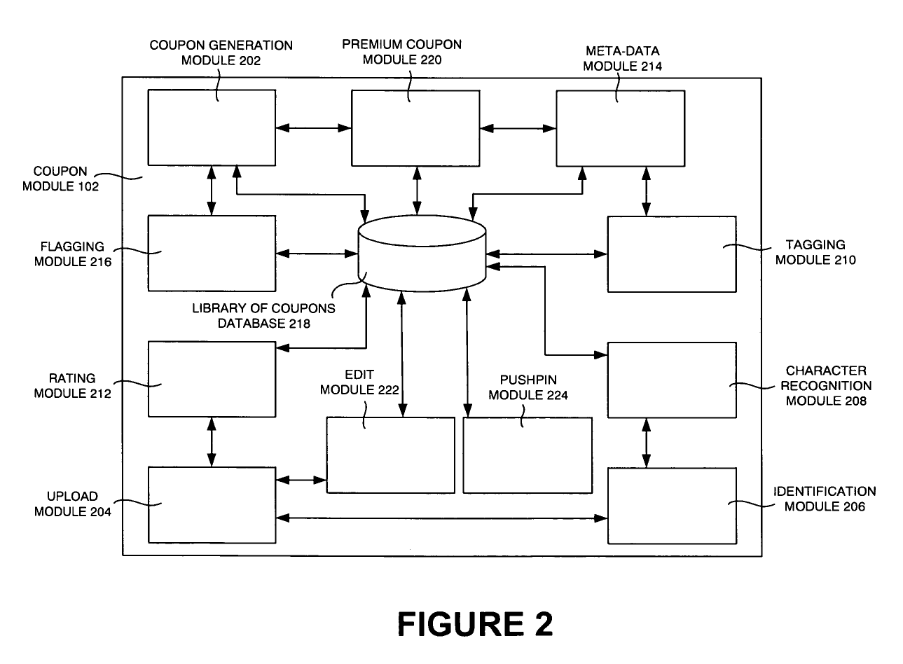

In one embodiment, a method includes automatically applying a location meta-data to a coupon when a user (e.g., the user 122A-N of FIG. 1) provides the coupon to a geo-spatial environment (e.g., the geo-spatial environment 120A-N of FIG. 1) based on a geographic marker of the user, storing the coupon in a library of coupons (e.g., the library of coupons database 218 of FIG. 2), searching the library of coupons based on the location meta-data based on a user request, and/or flagging (e.g., using the flagging module 216 of FIG. 2) certain coupons in the library of coupons as being expired based on a user response.

In another embodiment, a system includes a geo-spatial environment (e.g., the geo-spatial environment 120A-N of FIG. 1), having any number of business profiles and any number of residential profiles each marked above a three-dimensional view (e.g., 3D map view) of a neighborhood, a set of markers indicating particular ones of the business profiles which have coupons in the geo-spatial environment as being available for redemption and a central module (e.g., the central module 100 of FIG. 1) to manage the recognition, rewards, and/or promotion of user-generated coupons in the geo-spatial environment between interested users, each having residential profiles and/or business profiles and/or each indicating a physical location of the users.

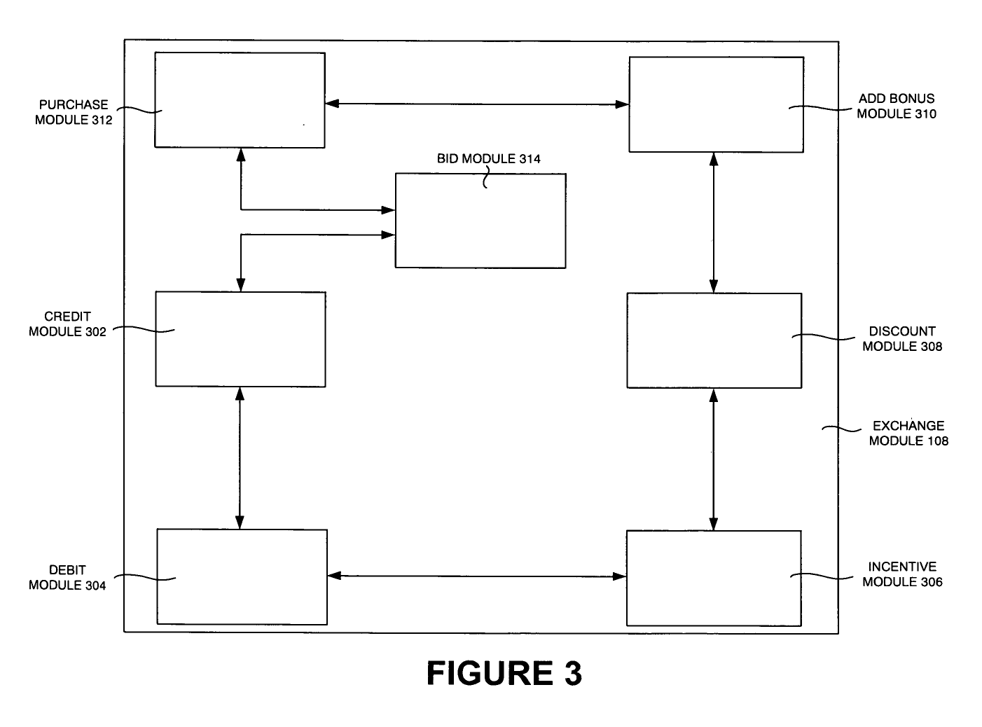

In yet another embodiment, a method includes capturing a location information of each user of a social network through an identification of a location of each user in a map, providing an incentive (e.g., using the incentive module 306 of FIG. 3) to the users of the social network to scan and upload coupons to the social network, automatically tagging (e.g., using the tagging module 210 of FIG. 2) the uploaded coupons based on the location information of each user and enabling debits and/or credits between users who participate in a user generated coupon exchange between parties in the social network by providing credits and/or debits between business and residential users of the social network based on a validity and/or redemption of the coupons in the social network.

FIG. 1 is a system view of a central module 100 communicating with a geo-spatial environment 120A-N through a network 114, according to one embodiment. Particularly, FIG. 1 illustrates the central module 100, a coupon module 102, an advertisement module 104, a map module 106, an exchange module 108, a search module 110, a profile module 112, the network 114, a residence 116, a business 118, the geo-spatial environment 120A-N, users 122A-N, distributors 124 and advertisers 126, according to one embodiment.

The central module 100 may manage recognition, rewards and/or promotion of user generated coupons having a profile (e.g., residential profile, business profile, etc.) associated with a location meta-data in the geo-spatial environment 120A-N. The central module 100 may also enable the advertisers 126 to place premium coupons in the geo-spatial environment 120A-N. The coupon module 102 may contain a set of coupons stored in the library of coupons (e.g., the library of coupons database 218 illustrated in FIG. 2) representing the products and/or services and/or may differentiate the premium coupons from the other coupons by highlighting the profiles of the premium coupons in the geo-spatial environment as being available for redemption.

The advertisement module 104 may enable the advertisers 126 to upload coupons online. The map module 106 may render the geo-spatial environment 120A-N concurrently representing neighboring places and profiles, using a set of markers indicating the availability status of the coupons. The exchange module 108 may provide an incentive (e.g., the incentive may be a portion of the value of the coupon) to the users 122A-N when the users 122A-N upload the valid coupon(s) and/or share a content meta-data that tags and identifies a source, a duration, a value and/or a description of the coupon in the geo-spatial environment 120A-N. The exchange module 108 may barter the credits and/or debits between users (e.g., a businesses and/or residential user) in the geo-spatial environment based on the validity and/or redemption of coupons in the social network.

The search module 110 may search the library of coupons (e.g., the library of coupons database 218 of FIG. 2) based on the location meta-data upon request (e.g., requests for the type of the coupon, value of the coupon etc.) by the users 122A-N. The profile module 112 may include business profiles and/or residential profiles indicating the location meta-data of the user 122A-N in the geo-spatial environment. The network 114 may enable efficient communication between the central module 100 and the geo-spatial environment 120A-N.

The residence 116 may represent a residential profile of an occupant and the business 118 may represent the business profile associated with the location meta-data of the user in the geo-spatial environment. The geo-spatial environment 120A-N may contain any number of business and/or residential profiles (e.g., each marked above the 3-dimensional view in the neighborhood).

The users 122A-N may be business and/or residential users who participate in the user generated coupon exchange between parties in the social network. The distributors 124 may dispense the set of coupons acquired from the business and/or residential users in the geo-spatial environment 120A-N. The advertisers 126 may be the entities interested in placing the premium coupons in the geo-spatial environment 120A-N through a bidding competition.

In the example embodiment illustrated in FIG. 1, the central module 100 communicates with the geo-spatial environment 120A-N through the network 114. The central module 100 directly communicates with the distributors 124 and the advertisers 126 as illustrated.

Furthermore, the location meta-data may be automatically applied to the coupon when the user (e.g., the users 122A-N of FIG. 1) who provides the coupon to the geo-spatial environment 120A-N based on the geographic marker of the user. For example, the user who provides the coupon may scan in a coupon received by the user through printed mail, and may upload the coupon to the geo-spatial environment 120A-N after registering location information in the geo-spatial environment.

In addition, the incentive may be provided to the user who provides the coupon to the geo-spatial environment 120A-N in exchange of providing the coupon and/or in exchange of sharing the content meta-data that tags and identifies the source, the duration, the value, and/or the description of the coupon. In one example embodiment, the incentive may be at least a portion of the value of the coupon, that may be applied as a credit to the user who provides the coupon to the geo-spatial environment 120A-N.

Furthermore, another user may be enabled to purchase the offering identified through the coupon in the geo-spatial environment 120A-N. Also, the coupon may be applied to the offering when the transaction between another user and the seller is processed. A premium coupon may also be generated (e.g., using the premium coupon module 220 of FIG. 2) in the geo-spatial environment 120A-N. The premium coupon may be highlighted in the search result when the advertiser(s) 126 pays the geo-spatial environment 120A-N to place the premium coupon in the geo-spatial environment 120A-N (e.g., the advertiser(s) 126 may bid along with other advertisers 126 to place the premium coupon in the search result based on a bidding competition between the advertisers tagged to the location meta-data and/or the content meta-data).

In addition, a modify operation on the coupon may be performed to correct and/or improve indexing of the coupon when any user of the geo-spatial network updates, modifies, creates, and tags the coupon. Moreover, the marker may be applied to graphically show the coupon in the geo-spatial wiki based social network along with other markers highlighting profiles of neighbors and businesses in a neighborhood.

The geo-spatial environment 120A-N may have any number of business profiles and/or residential profiles each marked above the three-dimensional view of the neighborhood. For example, a set of markers may indicate business profiles which have coupons in the geo-spatial environment 120A-N as being available for redemption. The central module 100 may manage recognition, rewards, and/or promotion of user-generated coupons in the geo-spatial environment 120A-N between interested ones of users, each having the residential profiles and/or business profiles, and each indicating the physical location of the users.

Furthermore, the central module 100 may enable businesses to place premium coupons in the geo-spatial environment 120A-N. The premium coupons may be ordered in search results based on the bidding across location-based and/or category-based dimensions. Also, the set of markers may appear only for a determined amount of time based on the meta-data identifying the valid term of the coupons and may automatically disappear from the geo-spatial environment 120A-N when the valid term expires.

FIG. 2 is an exploded view of the coupon module 102 of FIG. 1, according to one embodiment. Particularly, FIG. 2 illustrates a coupon generation module 202, an upload module 204, an identification module 206, a character recognition module 208, a tagging module 210, a rating module 212, a meta-data module 214, a flagging module 216, a library of coupons database 218, a premium coupon module 220, an edit module 222, and a pushpin module 224, according to one embodiment.

The coupon generation module 202 may generate coupons stored in the library of coupons database 218 based on the location meta-data and/or content meta-data. The upload module 204 may upload scanned coupons in the geo-spatial environment upon registering the location information of the user in the geo-spatial environment (e.g., the geo-spatial environment 120A-N of FIG. 1). The identification module 206 may identify the offerings (e.g., products and/or services) in the coupons in the geo-spatial environment when another user browses the library of coupons database 218 in singular and/or group fashion.

The character recognition module 208 may apply optical character recognition (e.g., OCR) technology to automatically add the location and/or content meta-data when the coupons are uploaded by the users (e.g., the user 122A-N of FIG. 1) to the geo-spatial environment (e.g., by scanning text from user-generated documents). The tagging module 210 may automatically tag the uploaded coupons in the geo-spatial environment based on the location information of the user. The rating module 212 may place the rating and/or the comment boards of the uploaded coupons based on the user feedback provided in the geo-spatial environment, and/or may enable the ratings to recognize prolific and/or popular users who provide coupons to be shared in the geo-spatial environment.

The meta-data module 214 may contain the location meta-data and/or content meta-data associated with the coupons provided by the user to the geo-spatial environment. The flagging module 216 may flag the validity status of certain coupons in the library of coupons database 218. The library of coupons database 218 may be a database that holds records of the coupons uploaded by the users in the geo-spatial environment.

The premium coupon module 220 may generate the premium coupons when the advertiser(s) (e.g., the advertisers 126 of FIG. 1) pays to place the premium coupons in the geo-spatial environment based on the bidding across location-based and category-based dimensions. The edit module 222 may perform the modify operation on the coupon to correct and improve indexing of the coupon when the user updates, modifies, creates and/or tags the coupon. The pushpin module 224 may visually display a set of pushpins (e.g., markers, icons) in the geo-spatial environment highlighting the particular location (e.g., the set of coupons may be redeemable).

In the example embodiment illustrated in FIG. 2, the library of coupons database 218 communicates with the coupon generation module 202, the upload module 204, the character recognition module 208, the tagging module 210, the rating module 212, the meta-data module 214, the flagging module 216, the premium coupon module 220, the edit module 222, and the pushpin module 224. The identification module 206 communicates with the upload module 204 and character recognition module 208. The premium coupon module 220 communicates with the coupon generation module 202 and meta-data module 214, according to the embodiment illustrated in FIG. 2.

Furthermore, the location meta-data may be automatically applied to the coupon when the user provides the coupon to the geo-spatial environment (e.g., the geo-spatial environment 120A-N of FIG. 1) based on the geographic marker of the user. The coupon may be stored in the library of coupons (e.g., the library of coupons database 218 of FIG. 2). In addition, the library of coupons may be searched (e.g., through the search module 110 of FIG. 1) based on the location meta-data based on the user request. Moreover, certain coupons in the library of coupons may be flagged as being expired based on the user response. Furthermore, a premium coupon may be generated in the geo-spatial environment which may be highlighted in the search result when the advertiser (e.g., the advertiser 126 of FIG. 1) pays the geo-spatial environment to place the premium coupon in the geo-spatial environment.

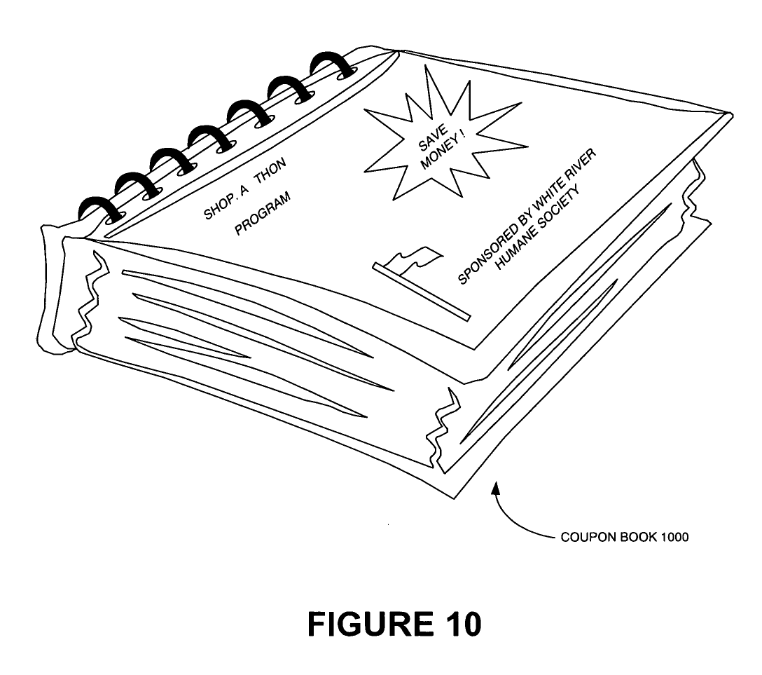

Also, the users may be enabled to browse the library of coupons (e.g., through the library of coupons database 218 of FIG. 2) in singular and/or group fashion, and/or to print out the coupon page and/or the coupon book (e.g., a coupon book 1000 of FIG. 10) based on location, topic, description, interest, value, and/or business name. Additionally, the optical character recognition technology (e.g., using the character recognition module 208 of FIG. 2) may be applied to the coupon when it is uploaded to automatically add the location and/or content meta-data in the library of coupons.

The rating and/or the comments board of uploaded coupons may be placed in the geo-spatial environment based on user feedback provided in the geo-spatial environment. The ratings and/or the comments board may be enabled to recognize prolific and popular ones of the users who provide coupons to be shared in the geo-spatial environment. Moreover, the location information of each user of the social network may be captured through the identification of the location of each user in the map. In addition, the uploaded coupons may be automatically tagged (e.g., using the tagging module 210 of FIG. 2) based on the location information of each user.

Popular users of the social network may be recognized through ratings and/or popularity score in exchange of sharing coupons with other parties in the social network. Moreover, a set of premium coupons may be placed in the social network that are visually displayed along with other coupons in the map through a set of pushpins (e.g., using a pushpin module 224 of FIG. 2) that highlight particular locations at which the set of premium coupons and the other coupons are redeemable.

FIG. 3 is an exploded view of the exchange module 108 of FIG. 1, illustrating a credit module 302, a debit module 304, an incentive module 306, a discount module 308, an add bonus module 310, a purchase module 312, and a bid module 314, according to one embodiment.

The credit module 302 may provide the credit to the providers of coupons in the geo-spatial environment. The debit module 304 may provide debits to the business and/or residential users based on the validity and/or redemption of the coupons in the social network (e.g., in the geo-spatial environment). The incentive module 306 may provide an incentive (e.g., a portion of the value of the coupon) to the user of the social network to scan and upload the coupons to the social network. The discount module 308 may provide concession in the value of the coupons to the user in the geo-spatial environment.

The add bonus module 310 may provide a bonus to the user who provides the coupon when the coupon is redeemed by another user in the geo-spatial environment. The purchase module 312 may apply the offering identified through the coupon in the geo-spatial environment when the transaction between another user and the seller is processed. The bid module 314 may process biddings between the different advertisers to place the premium coupons in the geo-spatial environment.

In the example embodiment illustrated in FIG. 3, the credit module 302 communicates with the debit module 304 and the bid module 314. The incentive module 306 as illustrated in FIG. 3 communicates with the debit module 304 and the discount module 308. The add bonus module 310 interacts with the discount module 308 and the purchase module 312. The purchase module 312 communicates with the bid module 314, according to the example embodiment illustrated in FIG. 3.

Furthermore, the incentive may be provided to a user who provides the coupon to the geo-spatial environment (e.g., through the incentive module 306 of FIG. 3) in exchange of providing the coupon and/or in exchange of sharing the content meta-data that tags and identifies the source, the duration, the value, and/or the description of the coupon. In addition, the coupon may be debited (e.g., using the debit module 304 of FIG. 3) against the user who provides the coupon to the geo-spatial environment when it is flagged as expired prior to being redeemed by another user in the geo-spatial environment.

Also, the added bonus may be provided to the user who provides the coupon when the coupon is redeemed by another user in the geo-spatial environment prior to expiry of the coupon. Further, the incentive may be provided to the users of the social network to scan and upload coupons to the social network. The debits and/or credits may be enabled between users who participate in a user generated coupon exchange between parties in the social network by providing credits and/or debits between business and residential users of the social network based on the validity and/or redemption of the coupons in the social network (e.g., in the geo-spatial environment).

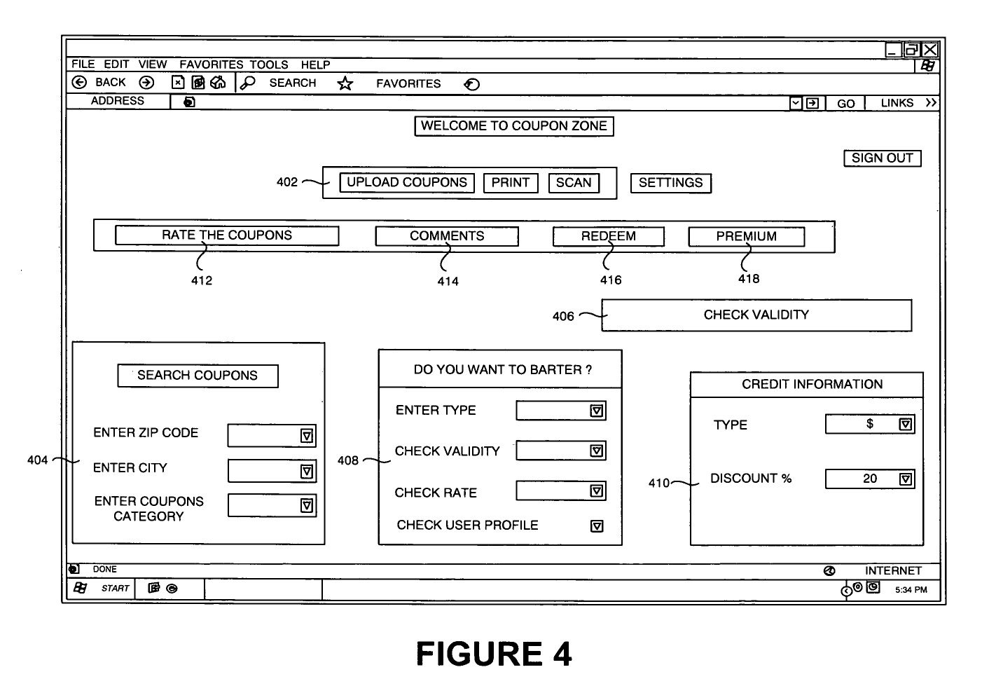

FIG. 4 is a user interface view of the coupon module 102 of FIG. 1, according to one embodiment. Particularly, FIG. 4 illustrates an upload coupons option 402, a search coupons option 404, a check validity option 406, a do you want to barter? option 408, a credit information option 410, a rate the coupons option 412, a comments option 414, a redeem option 416 and a premium option 418, according to one embodiment.

The upload coupons option 402 may enable the user of the geo-spatial environment to scan and upload coupons. In addition, the upload coupons option 402 may allow the user to print out a coupon page and/or a coupon book based on location, topic, description, interest, value and/or business name. The search coupon option 404 may enable any user to locate coupons based on location and/or category meta-data in the geo-spatial environment. The check validity option 406 may offer information associated with the validity of the coupons stored in the library of coupons.

The do you want to barter? option 408 may enable users of the geo-spatial environment to barter products and/or services through exchange of coupons. The credit information option 410 may display the credit information associated with the user who provides a coupon to the geo-spatial environment and/or shares the content meta-data. The rate the coupons option 412 may enable the user to analyze and/or provide the feedback on the uploaded coupons so that the ratings may be generated based on the user provided feedback.

The comments option 414 may enable the users of the geo-spatial environment to post comments on the uploaded coupons in the geo-spatial environment. The redeem option 416 may enable the users to trade in the offerings identified through the coupons in the geo-spatial environment. The premium option 418 may display the premium coupons available at a particular location in the geo-spatial environment through a set of highlighted markers and/or may also enable the advertisers (e.g., the advertisers 126 of FIG. 1) to place the premium coupons in the geo-spatial environment.

In the example embodiment illustrated in FIG. 4, the user interface view may enable the users of the geo-spatial environment to scan and/or upload coupons using the option 402 and search for the desired coupons based on location using the search coupons option 404 based on the location and/or category of the coupons. The users may also validate the coupons available in the geo-spatial environment through the check validity option 406. The credit details in the exchange of coupons may be provided through the credit info option 410.

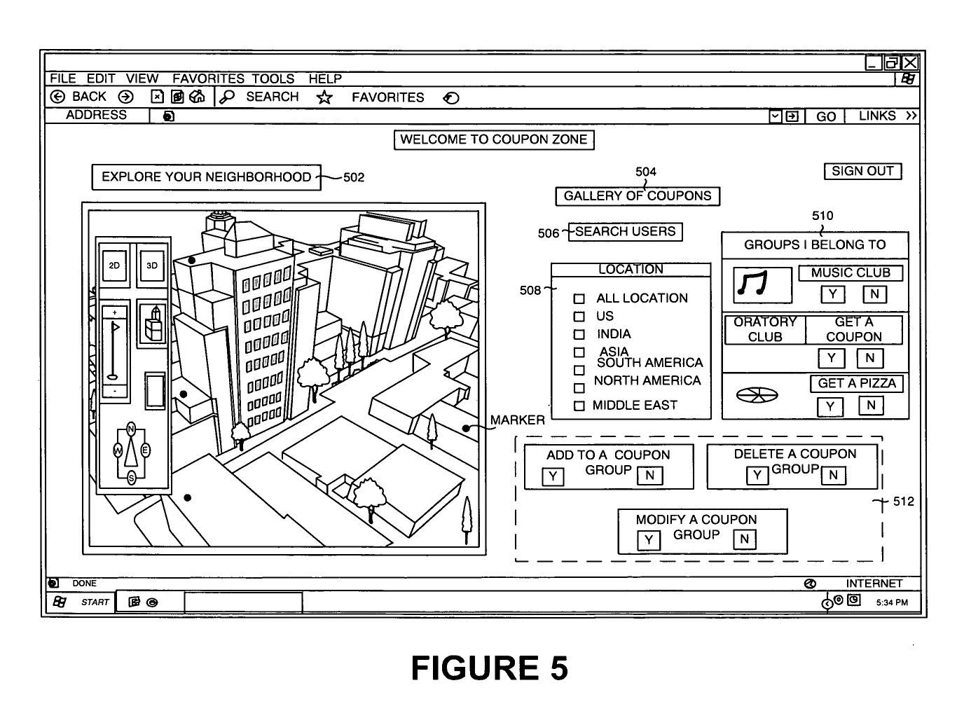

FIG. 5 is a user interface view of a coupon zone in a geo-spatial environment, illustrating an explore your neighborhood option 502, a gallery of coupons link 504, a search users field 506, a location field 508, a groups I belongs to view 510, and an edit coupon groups view 512, according to one embodiment.

The explore your neighborhood option 502 may enable the user to explore the neighborhood in a geo-spatial environment (e.g., to graphically visualize the location of the coupons in a geo-spatial, wiki-based social network, indicated through markers). The gallery of coupons 504 may contain a library of any number of coupons. The content information (e.g., the type, the location, the source, the value and/or the validity etc.) associated with the coupons may be displayed by selecting the gallery of coupons link 504. The search users field 506 may permit the user to browse and/or search for the coupons in the geo-spatial environment based on location meta-data and/or content metadata.

The location field 508 may be used to select the location (e.g., US, India, Australia etc) of the coupons in the geo-spatial environment. The groups I belong to option 510 may display various group that the claimed profile user belongs to. The edit coupon groups view 512 may include options for adding/uploading a new coupon, deleting an expired coupon and/or modifying the content information of the coupon.

In the example embodiment illustrated in FIG. 5, the explore your neighborhood option 502 may visualize a graphical representation of the neighborhood in the geo-spatial environment and/or display markers indicating the location of coupons in the geo-spatial environment. In addition, the users can upload the coupons to the geo-spatial environment, delete the coupon from the library of coupons database 218 on expiry, and/or modify the meta-data (e.g., location, content etc.,) associated with the coupons. Further, the user interface of the coupon zone may also enable the users to search the coupons based on the type of coupon, location of the coupon and/or validity of the coupon, etc. in the geo-spatial environment.

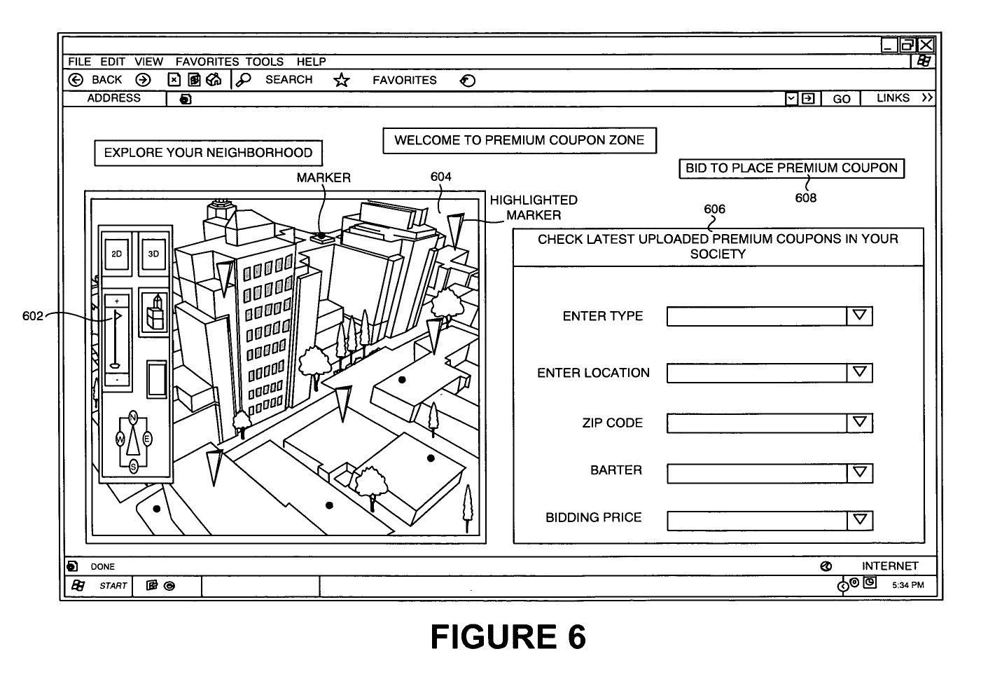

FIG. 6 is a user interface view of the premium coupon module 220 of FIG. 2, illustrating a toolbar option 602, a social community view 604, a check latest uploaded premium coupons in your society option 606 and a bid option 608, according to one embodiment.

The toolbar option 602 may enable the user to view a graphical representation of the virtual world to any desired scale and/or may also enable the user to visualize the placement of markers indicating the location of coupons in a geo-spatial environment (e.g., on a map). The social community 604 may display the set of markers indicating business profiles and/or residential profiles that have coupons in the geo-spatial environment available for redemption.

The check latest uploaded premium coupons in your society option 606 may enable the user to search for the latest premium coupons in the gallery of coupons (e.g., a gallery of coupons based on the location, the zip code, and/or the type of coupons). The bid option 608 may allow advertisers (e.g., the advertisers 126 of FIG. 1) in the geo-spatial environment to bid along with other advertisers for placing the premium coupon in the geo-spatial environment. In the example embodiment illustrated in FIG. 6, the user interface may graphically display, in the map, the set of markers associated with the placement of the premium coupons in the geo-spatial environment, and/or may distinguish the premium coupons from the other coupons by highlighting the premium coupons in the search results. The user interface view may also enable another user to search for the latest uploaded premium coupons based on the type, the location, the zip code, the bidding price and/or the barter availability of the coupons.

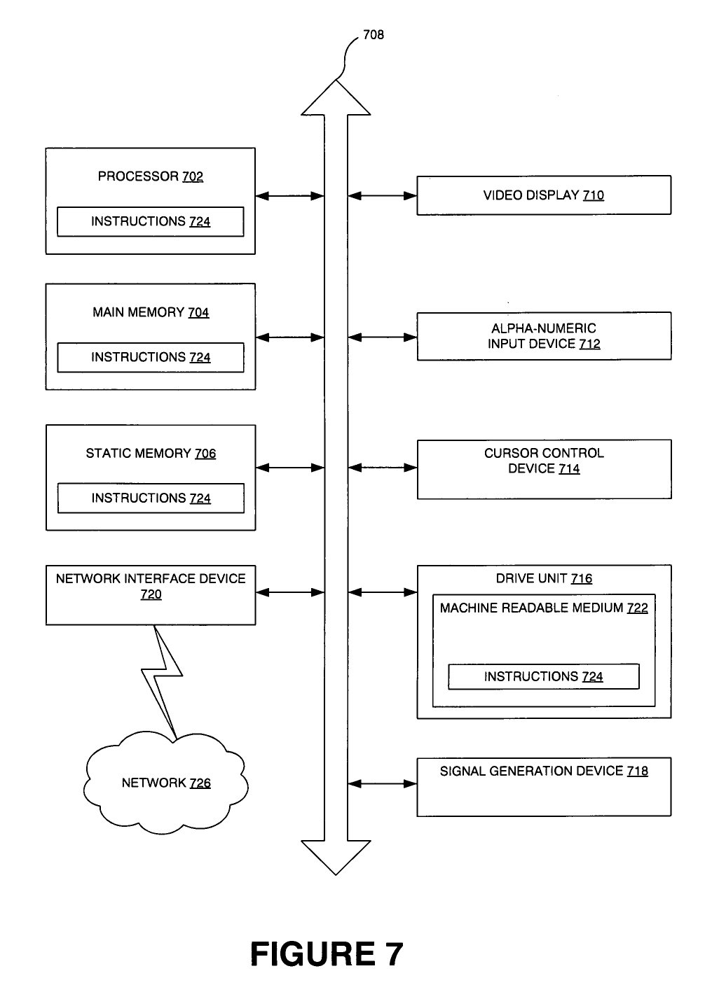

FIG. 7 is a diagrammatic system view 700 of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or a data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, keyboard and/or any other input device of text (e.g., a special device to aid the physically handicapped). The cursor control device 714 may be a pointing device such as a mouse.

The drive unit 716 may be a hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from the network 726. The machine readable medium 722 may provide instructions on which any of the methods disclosed herein may be performed. The instructions 724 may provide source code and/or data code to the processor 702 to enable any one/or more operations disclosed herein.

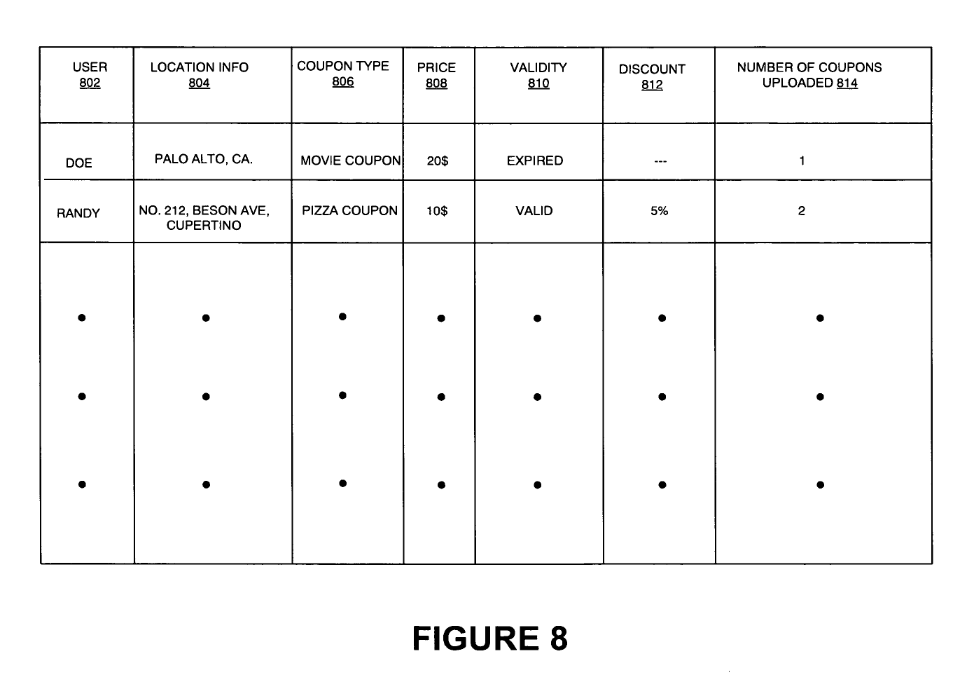

FIG. 8 is a table view of data referenced by the central module 100 of FIG. 1, illustrating a user field 802, a location info field 804, a coupon type field 806, a price field 808, a validity field 810, a discount field 812, and a number of coupons uploaded field 814, according to one embodiment.

The user field 802 may display name(s) of the user(s) of the geo-spatial environment (e.g., the geo-spatial environment 120A-N of FIG. 1). The location info field 804 may display location meta-data associated with the users who provided the coupon to the geo-spatial environment. The coupon type field 806 may display the various categories of the coupons (e.g., coupons for pizza, movie, etc.) available in the library of coupons in the geo-spatial environment.

The price field 808 may offer information associated with the value of each coupon provided by the user. The validity field 810 may indicate whether the term of the coupon is expired. The discount field 812 may provide information associated with the discounts available on the coupons in the geo-spatial environment. The number of coupons uploaded field 814 may provide the number of coupons of any particular type available in the geo-spatial environment.

In the example embodiment illustrated in FIG. 8, the user field 802 displays “Doe” in the first row and “Randy” in the second row of the user field column 802. The location info field 804 displays “Palo Alto, CA” in the first row and “No. 212, Beson Ave, Cupertino” in the second row of the location info field column 804. The coupon type field 806 displays “movie coupon” in the first row and “pizza coupon” in the second row of the coupon type field column 806. The price field 808 displays “20$” in the first row and “10$” in the second row of the price field column 808.

The validity field 810 displays “expired” in the first row and “valid” in the second row of the validity field column 810. The discount field 812 displays “-” in the first row and “5%” in the second row of the discount field column 812. The number of coupons uploaded field 814 displays “1” in the first row and “2” in the second row of the number of coupons field column 814.

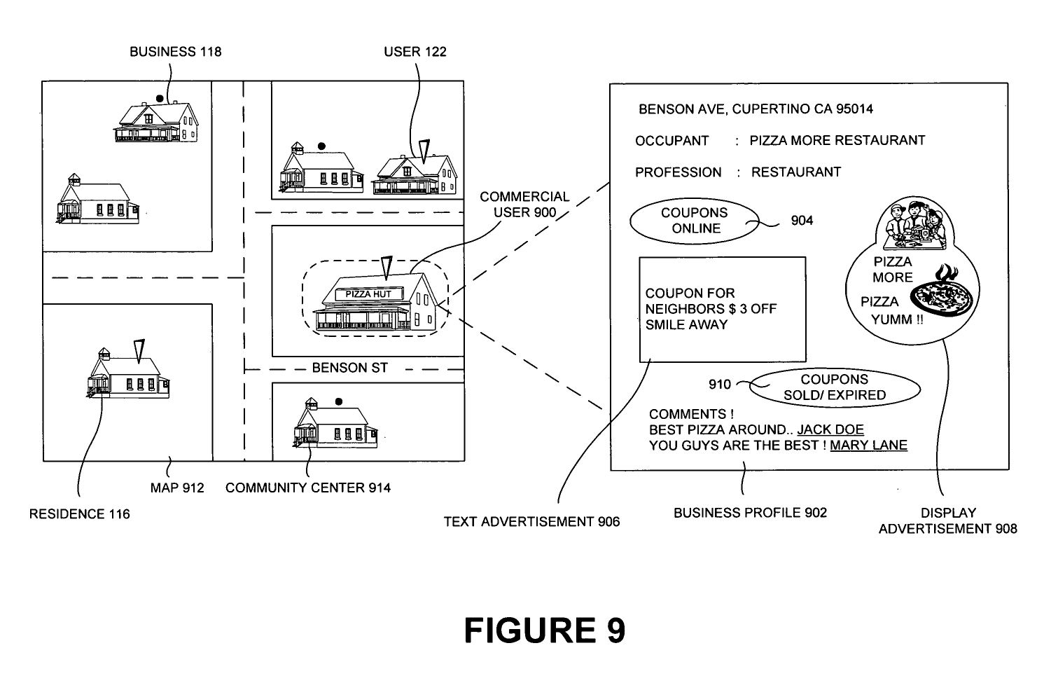

FIG. 9 is a user interface view of mapping of a customizable business profile 902 of a commercial user 900, illustrating the commercial user 900, the customizable business profile 902, a coupons online option 904, a text advertisement 906, a display advertisement 908, a coupons sold/expired 910, a map 912, a community center 914, the residence 116, the business 118, and the user 122, according to one embodiment.

The commercial user 900 may be associated with the customizable business profile 902 uploading the coupons in the geo-spatial environment. The customizable business profile 902 may be a profile of any business firm (e.g., restaurant, movie theaters, supermarket, etc.) that may contain information such as an address, an occupant name, and/or a profession of the customizable business.

The customizable business profile 902 may also enable the commercial user 900 to place online coupons for the products. The coupons online 904 may represent the coupons for sale and/or barter uploaded by the commercial user 902 in the geo-spatial environment. The text advertisement 906 may show the offerings for the neighbors (e.g., $3 off) of the customizable business identified through the coupons in the geo-spatial environment. The display advertisement 908 may display visual content and/or advertisements of the products of the customizable business that attract the users to buy the products and/or services of the customizable business. The coupons sold/expired 910 may depict coupons as expired based on the validity of the coupons and/or purchase/barter by the customers.

The map 912 may visualize graphically in the map view the business profiles and/or residential profiles and the set of markers indicating the availability of coupons in the neighborhood of the geo-spatial environment. The community center 914 may include public locations where members of a community gather for group activities, social support, public information, and other purposes. The residence 116 may represent the residences associated with the residential users in the neighborhood of the geo-spatial environment. The business 118 may represent the geographical location of the business in the neighborhood of the geo-spatial environment. The users 122A-N may be business and/or residential users who may participate in uploading and/or exchanging coupons in the geo-spatial environment.

In the example embodiment illustrated in FIG. 9, the mapping view may display a customized business profile 902 associated with the customized business in the geo-spatial environment which may contain the coupon details available for sale and/or for exchange in the geo-spatial environment.

FIG. 10 is an exemplary view of a coupon book 1000, illustrating the coupon book that may contain the set of coupons provided by the users in the geo-spatial environment, according to one embodiment.

In the example embodiment illustrated in FIG. 10, the coupon book 1000 may be a ticket and/or a document that can be exchanged for a financial discount and/or rebate. The coupon book 1000 may be scanned and uploaded by the users to the geo-spatial environment. Also, the set of coupons uploaded by the user may be stored in the library of coupons in the geo-spatial environment such that the other users interested in buying, distributing and/or exchanging coupons may access the coupon book 1000 based on location, topic, interests and/or value, etc.

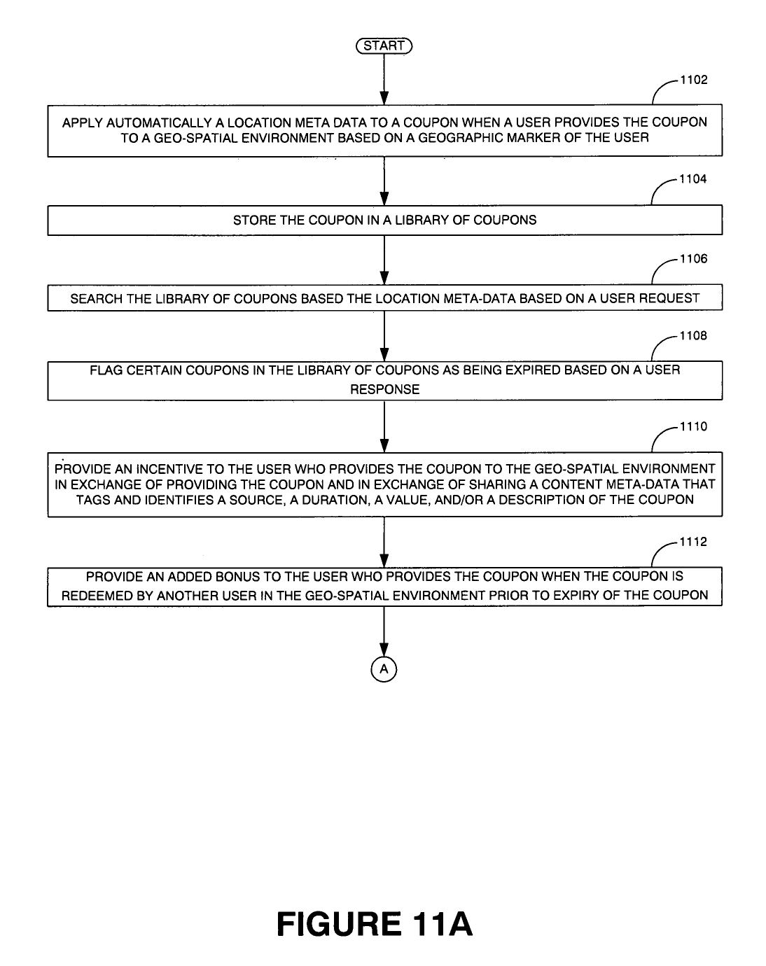

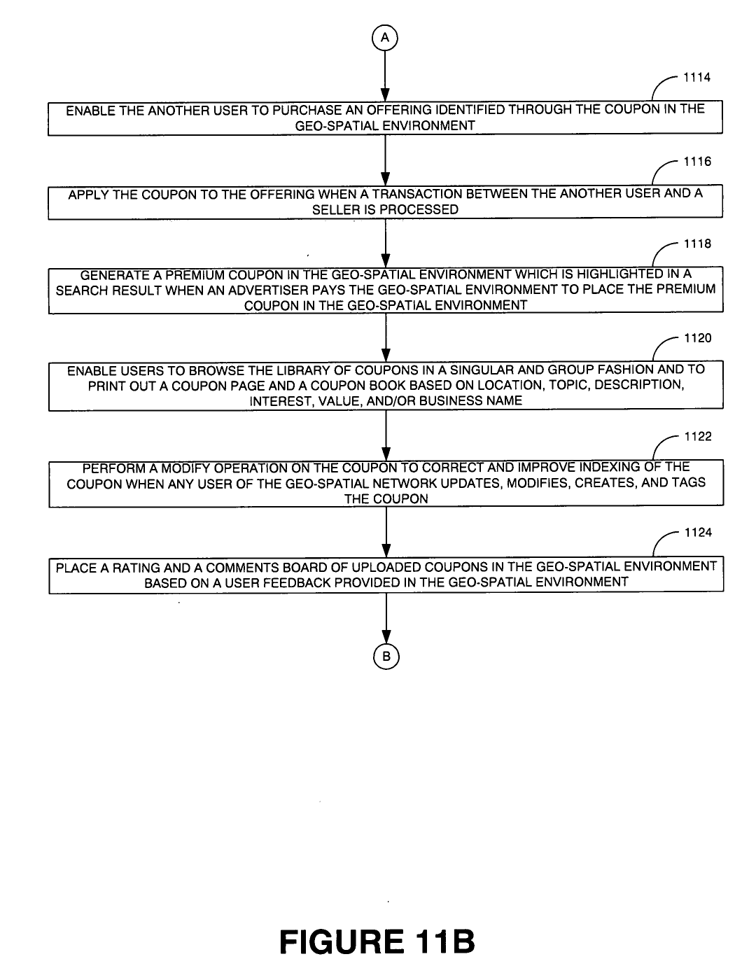

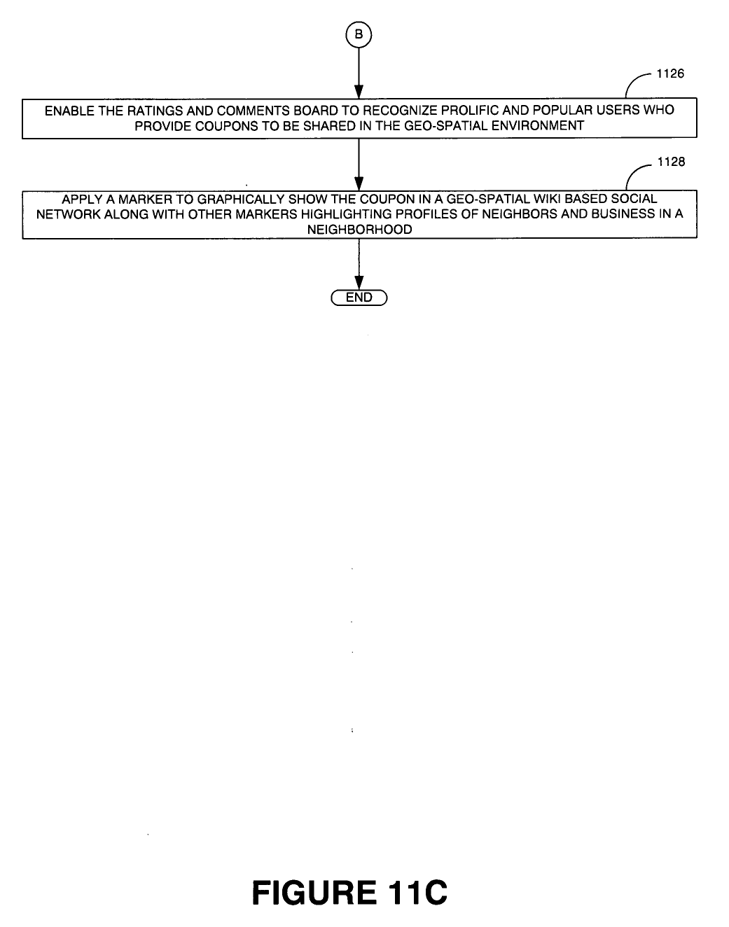

FIG. 11A is a process flow of generating coupons in a geo-spatial environment, according to one embodiment. In operation 1102, a location meta-data may be automatically applied to a coupon when a user provides the coupon to a geo-spatial environment (e.g., the geo-spatial environment 120A-N of FIG. 1) based on a geographic marker of the user. In operation 1104, the coupon may be stored in a library of coupons (e.g., the library of coupons database 218 of FIG. 2). In operation 1106, the library of coupons may be searched based on the location meta-data based on a user request. In operation 1108, certain coupons in the library of coupons may be flagged as being expired based on a user response.

In operation 1110, an incentive may be provided to the user who provides the coupon to the geo-spatial environment in exchange of providing the coupon and/or in exchange of sharing a content meta-data that tags and identifies a source, a duration, a value, and/or a description of the coupon (e.g., using the tagging module 210 of FIG. 2). In operation 1112, an added bonus may be provided to the user who provides the coupon when the coupon is redeemed by another user in the geo-spatial environment prior to expiry of the coupon.

FIG. 11B is a continuation of the process flow of FIG. 11A showing additional processes, according to one embodiment. In operation 1114, the another user may be enabled to purchase an offering identified through the coupon in the geo-spatial environment. In operation 1116, the coupon may be applied to the offering when a transaction between the another user and a seller is processed.

In operation 1118, a premium coupon may be generated in the geo-spatial environment which is highlighted in a search result when an advertiser pays the geo-spatial environment to place the premium coupon (e.g., using the premium coupon module 220 of FIG. 2) in the geo-spatial environment. In operation 1120, users may be enabled to browse the library of coupons (e.g., the library of coupons database 218 of FIG. 2) in a singular and group fashion and to print out a coupon page and/or a coupon book based on location, topic, description, interest, value, and/or business name. In operation 1122, a modify operation (e.g., using the edit module 222 of FIG. 2) on the coupon may be performed to correct and improve indexing of the coupon when any user of the geo-spatial network updates, modifies, creates, and/or tags the coupon. In operation 1124, a rating and/or a comments board of uploaded coupons may be placed in the geo-spatial environment based on a user feedback provided in the geo-spatial environment.

FIG. 11C is a continuation of the process flow of FIG. 11B showing additional processes, according to one embodiment. In operation 1126, the ratings and/or comments board may be enabled to recognize prolific and/or popular users who provide coupons to be shared in the geo-spatial environment. In operation 1128, a marker may be applied to graphically show the coupon in a geo-spatial wiki based social network along with other markers highlighting profiles of neighbors and business in a neighborhood.

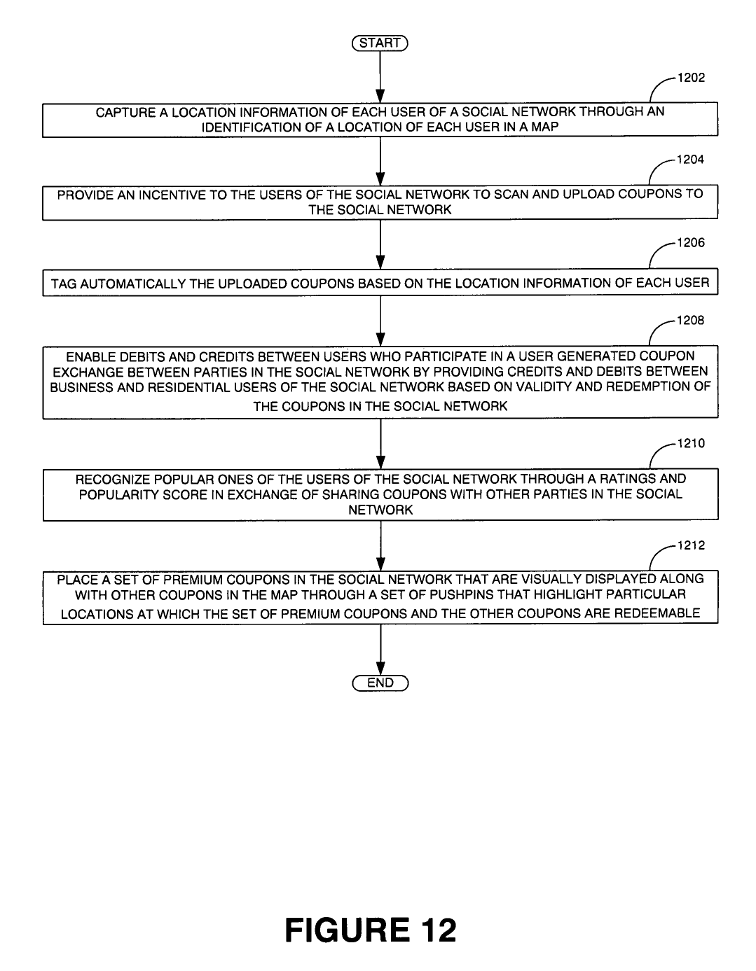

FIG. 12 is a process flow of exchanging the user generated coupons of the geo-spatial environment, according to one embodiment. In operation 1202, a location information of each user of a social network may be captured through an identification (e.g., using the identification module 206 of FIG. 2) of a location of each user in a map. In operation 1204, an incentive may be provided to the users of the social network to scan and upload (e.g., using the upload module 204 of FIG. 2) coupons to the social network. In operation 1206, the uploaded coupons may be tagged automatically based on the location information of each user.

In operation 1208, debits and credits may be enabled between users who participate in a user generated coupon exchange (e.g., using the exchange module 108 of FIG. 1) between parties in the social network by providing credits and debits between business and residential users of the social network based on validity and redemption of the coupons in the social network. In operation 1210, popular ones of the users of the social network may be recognized through a ratings and popularity score in exchange of sharing coupons with other parties in the social network. In operation 1212, a set of premium coupons may be placed in the social network that are visually displayed along with other coupons in the map through a set of pushpins that highlight particular locations at which the set of premium coupons and the other coupons are redeemable.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example the central module 100, the coupon module 102, the advertisement module 104, the map module 106, the exchange module 108, the search module 110, the profile module 112, the coupon generation module 202, the upload module 204, the identification module 206, the character recognition module 208, the tagging module 210, the rating module 212, the meta-data module 214, the flagging module 216, the premium coupon module 220, the edit module 222, the pushpin module 224, the credit module 302, the debit module 304, the incentive module 306, the discount module 308, the add bonus module 310, the purchase module 312, bid module 314 and other modules of FIGS. 1-12 may be embodied through a central circuit, a coupon circuit, a advertisement circuit, a map circuit, an exchange circuit, a search circuit, a profile circuit, a coupon generation circuit, an upload circuit, an identification circuit, a character recognition circuit, a tagging circuit, a rating circuit, a meta-data circuit, a flagging circuit, a premium coupon circuit, an edit circuit, a pushpin circuit, a credit circuit, a debit circuit, an incentive circuit, a discount circuit, an add bonus circuit, a purchase circuit, a bid circuit and other circuits using one or more of the technologies described herein.

In addition, it will be appreciated that the various operations, processes, and methods disclosed herein may be embodied in a machine-readable medium and a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
automatically applying a location meta-data to a coupon when a user provides the coupon to a geo-spatial environment based on a geographic marker of the user;
storing the coupon in a library of coupons;
searching the library of coupons based on the location meta-data based on the user request; and
flagging certain coupons in the library of coupons as being expired based on a user response.

2. The method of claim 1 further comprising providing an incentive to the user who provides the coupon to the geo-spatial environment in exchange of providing the coupon and in exchange of sharing a content meta-data that tags and identifies at least one of a source, a duration, a value, and a description of the coupon.

3. The method of claim 2 wherein the incentive is at least a portion of the value of the coupon, and wherein the incentive is applied as a credit to the user who provides the coupon to the geo-spatial environment.

4. The method of claim 3 wherein the coupon is debited against the user who provides the coupon to the geo-spatial environment when it is flagged as expired prior to being redeemed by another user in the geo-spatial environment.

5. The method of claim 2 further comprising providing an added bonus to the user who provides the coupon when the coupon is redeemed by another user in the geo-spatial environment prior to expiry of the coupon.

6. The method of claim 5 further comprising:
enabling the another user to purchase an offering identified through the coupon in the geo-spatial environment; and
applying the coupon to the offering when a transaction between the another user and a seller is processed.

7. The method of claim 2 further comprising generating a premium coupon in the geo-spatial environment which is highlighted in a search result when an advertiser pays the geo-spatial environment to place the premium coupon in the geo-spatial environment.

8. The method of claim 7 wherein the advertiser bids along with other advertisers to place the premium coupon in the search result based on a bidding competition between advertisers tagged to at least one of the location meta-data and the content meta-data.

9. The method of claim 8 further comprising enabling users to browse the library of coupons in a singular and group fashion, and enabling the users to print out a coupon page and a coupon book based on at least one of a location, a topic, a description, a interest, a value, and a business name.

10. The method of claim 9 wherein the user who provides the coupon scans in a coupon received by the user through printed mail and uploads the coupon to the geo-spatial environment after registering location information in the geo-spatial environment, and wherein an optical character recognition technology is applied to the coupon when it is uploaded to automatically add the location and content meta-data in the library of coupons.

11. The method of claim 10 further comprising performing a modify operation on the coupon to correct and improve indexing of the coupon when any user of the geo-spatial network updates, modifies, creates, and tags the coupon.

12. The method of claim 10 further comprising:
placing a rating and comments board of uploaded ones of the coupon in the geo-spatial environment based on a user feedback provided in the geo-spatial environment; and
enabling the ratings and comments board to recognize prolific and popular ones of the users who provide coupons to be shared in the geo-spatial environment.

13. The method of claim 11 further comprising applying a marker to graphically show the coupon in a geo-spatial wiki based social network along with other markers highlighting profiles of neighbors and businesses in a neighborhood.

14. The method of claim 1 in a form of a machine-readable medium embodying a set of instructions that, when executed by a machine, causes the machine to perform the method of claim 1.

15. A system comprising:
a geo-spatial environment having a plurality of business profiles and a plurality of residential profiles each marked above a three-dimensional view of a neighborhood;
a set of markers indicating particular ones of the business profiles which have coupons in the geo-spatial environment as being available for redemption; and
a central module to manage at least one of recognition, rewards, and promotion of user-generated coupons in the geo-spatial environment between interested ones of users each having at least one of residential profiles and business profiles and each indicating a physical location of the users.

16. The system of claim 15 wherein the central module to enable businesses to place premium coupons in the geo-spatial environment which are ordered in search results based on a bidding across location-based and category-based dimensions.

17. The system of claim 16 wherein the set of markers appear only for a determined amount of time based on a meta-data identifying a valid term of the coupons, and wherein the set of markers automatically disappear from the geo-spatial environment when the valid term expires.

18. A method comprising:
capturing a location information of each user of a social network through an identification of a location of each user in a map;
providing an incentive to the users of the social network to scan and upload coupons to the social network;
automatically tagging the uploaded coupons based on the location information of each user; and
enabling debits and credits between users who participate in a user generated coupon exchange between parties in the social network by providing credits and debits between business and residential users of the social network based on validity and redemption of the coupons in the social network.

19. The method of claim 18 further comprising recognizing popular ones of the users of the social network through a ratings and popularity score in exchange of sharing coupons with other parties in the social network.

20. The method of claim 19 further comprising placing a set of premium coupons in the social network that are visually displayed along with other coupons in the map through a set of pushpins that highlight particular locations at which the set of premium coupons and the other coupons are redeemable.
